(19) United States
(12) Patent Application Publication
(10) Pub. No.: US 2015/0348307 A1
(43) Pub. Date: Dec. 3, 2015

(54) APPARATUS AND METHOD OF TRAVERSING ACCELERATION STRUCTURE IN RAY TRACING

(71) Applicant: SAMSUNG ELECTRONICS CO., LTD., Suwon-si (KR)

(72) Inventors: Jaedon LEE, Suwon-Si (KR); Youngsam SHIN, Suwon-si (KR); Wonjong LEE, Suwon-si (KR); Seokjoong HWANG, Suwon-si (KR)

(73) Assignee: SAMSUNG ELECTRONICS CO., LTD., Suwon-si (KR)

(21) Appl. No.: 14/722,771

(22) Filed: May 27, 2015

(30) Foreign Application Priority Data
May 27, 2014 (KR) 10-2014-0063726

(51) Int. Cl. G06T 15/06

(52) U.S. Cl. CPC G06T 15/06

(57) ABSTRACT

Provided is an apparatus and method of traversing an acceleration structure (AS) in a ray tracing. The method includes determining whether each child node of a target node that is included in the AS intersects a ray, determining a type of a child node that intersects the ray; and performing an operation corresponding to a leaf node, in response to the child node being the leaf node, thereby reducing a time taken to traverse the AS.

### CROSS-REFERENCE TO RELATED APPLICATION

This application claims the benefit under 35 USC 119(a) of Korean Patent Application No. 10-2014-0063726, filed on May 27, 2014, in the Korean Intellectual Property Office, the entire disclosure of which is incorporated herein by reference for all purposes.

### BACKGROUND

1. Field

The following description relates to apparatuses and methods of traversing an acceleration structure in a ray tracing system.

2. Description of Related Art

Three-dimensional (3D) rendering refers to image processing for synthesizing 3D object data into an image that is seen from a viewpoint of a camera.

Rasterization is an example of rendering, which involves generating an image by projecting a 3D object onto an image plane. Ray tracing is another example of rendering, which involves generating an image by tracing a path of light that is incident along a ray through each pixel in an image plane from a viewpoint of a camera.

Ray tracing may generate a high-quality image because physical properties (e.g., reflection, refraction, and transmission) of light are reflected on a result of rendering. However, it is difficult to perform rendering at a high speed because of the large amount of computation involved. Processes requiring lots of computation in ray tracing include a process of generating and traversing an acceleration structure (AS) in which scene objects to be rendered are spatially divided and a process of performing an intersection test (IST) between a ray and a primitive.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Provided are apparatuses and methods of efficiently traversing an acceleration structure (AS) in ray tracing by determining a type of a child node during an AS traversal process and preferentially determining an object to be traversed according to the type of the child node.

In one general aspect, there is provided a method of traversing an acceleration structure (AS) in a ray tracing system includes determining whether each child node of a target node that is included in the AS intersects a ray, determining a type of a child node that intersects the ray, and performing an operation corresponding to a leaf node, in response to the child node being the leaf node.

The method may include determining a child node that is not the leaf node as a next target node, the performing of the operation comprises generating a list of primitives included in the leaf node, and determining whether at least one primitive included in the primitives intersects the ray.

The performing of the operation may include extracting a child node stored in a stack, in response to the each child node of the target node being a leaf node, determining the extracted child node as a next target node, and determining whether primitives that are included in the each child node of the target node intersects the ray.

The determining of whether the primitives intersect the ray may include generating a list of the primitives that are included in the each child node of the target node, and determining whether each primitive in the generated list intersects the ray.

The performing of the operation may include setting a child node whose intersection distance to the ray is the shortest from among child nodes whose types are different to a next target node, in response to the child node being the leaf node, and determining whether at least one primitive included in the one child node intersects the ray.

The target node may include type information of the each child node.

The target node may include index information for identifying each child node whose types is the same.

The index information may be index information of at least one primitive that is included in the leaf node, in response to the type of the child node being the leaf node.

The target node may include child nodes and the determining of whether the each child node intersects the ray comprises simultaneously determining whether the child nodes of the target node intersect the ray.

In another general aspect, there is provided an apparatus for traversing an acceleration structure (AS) in a ray tracing system, the apparatus including an intersection tester configured to determine whether each child node of a target node that is included in the AS intersects a ray, a type determiner configured to determines a type of a child node that intersects the ray, and a controller configured to perform an operation corresponding to a leaf node, in response to the child node being the leaf node.

The controller may be further configured to determine a child node that is not the leaf node as a next target node and to determine whether at least one primitive included in the leaf node intersects the ray.

In response to the each child node of the target node being a leaf node, the controller may be further configured to extract a child node that is stored in a stack, determine the extracted child node as a next target node, and determine whether primitives included in the each child node of the target node intersects the ray.

The intersection tester may be further configured to generate a list of the primitives that are included in the each child node of the target node and to determine whether each primitive included in the generated list intersects the ray.

The intersection tester may be further configured to calculate a hit point between the ray and the each primitive, wherein the hit point is expressed in coordinates.

The intersection tester may be further configured to determine whether the each child node of the target node intersects a ray based on the a hexahedral space occupied by the each child node.

The controller may be further configured to set a child node whose intersection distance to the ray is the shortest from among child nodes whose types are different to a next target node, in response to the child node being the leaf node, and to determine whether at least one primitive included in the one child node intersects the ray.

The target node may include type information of each of the child nodes.

The target node may include index information for identifying each child node whose types is the same.

The index information may be index information about at least one primitive that is included in the leaf node, in response to the type of the child node being the leaf node.

The target node may include child nodes and the intersection tester may be further configured to simultaneously determine whether the child nodes of the target node intersect the ray.

The controller may be further configured to track information regarding child nodes that do not intersect the ray.

The intersection tester may be further configured to determine whether each child node intersects a ray based on at least one of memory address in which the child node is stored, an index indicating the child node, a type information of the child node, or a bounding box information of the child node.

Other features and aspects will be apparent from the following detailed description, the drawings, and the claims.

### BRIEF DESCRIPTION OF THE DRAWINGS

FIG. 1 is a diagram illustrating an example of ray tracing.

FIG. 2 is a diagram illustrating an example of a ray tracing apparatus.

FIG. 3 is a diagram illustrating an example of an apparatus for traversing an acceleration structure (AS) in the ray tracing apparatus.

FIGS. 4A through 4D are diagrams illustrating examples of an AS traversal process in the ray tracing apparatus.

FIG. 5 is a diagram illustrating an example explaining a data structure in which information about any child node of a target node is stored.

FIG. 6 is a diagrams illustrating an example of a method of traversing an AS in the ray tracing apparatus.

FIG. 7 is a diagrams illustrating an example of an AS traversal process in the ray tracing apparatus.

FIG. 8 is a diagrams illustrating an example of explaining an operation between a traversal (TRV) unit and an intersection test (IST) unit in the ray tracing apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses, and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

As used herein, the term “and/or” includes any and all combinations of one or more of the associated listed items. Expressions such as “at least one of,” when preceding a list of elements, modify the entire list of elements and do not modify the individual elements of the list.

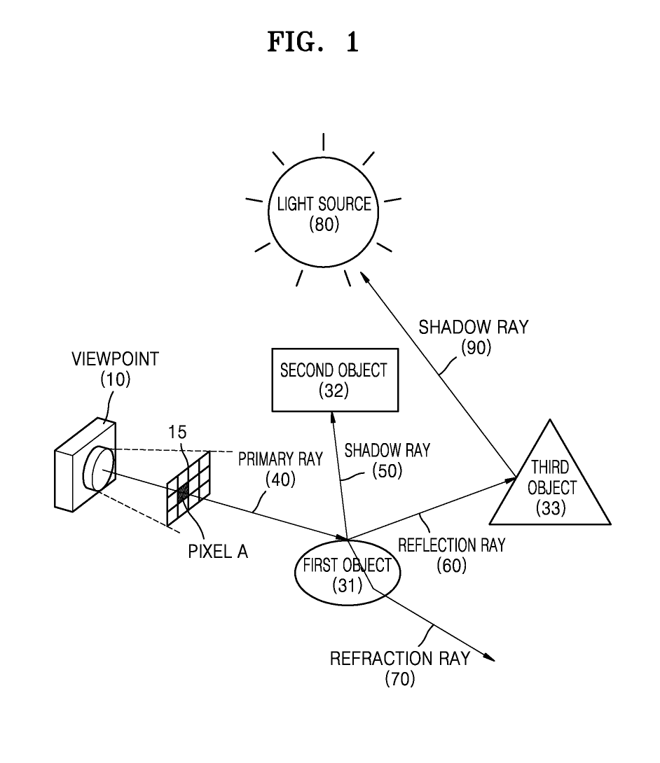

FIG. 1 is a diagram illustrating an example of ray tracing.

As shown in FIG. 1, a three-dimensional (3D) model may include a light source 80, a first object 31, a second object 32, and a third object 33. Although each of the first object 31, the second object 32, and the third object 33 is a 3D object, for convenience of explanation and depiction they have been depicted as a two-dimensional (2D) object in FIG. 1.

In this case, it may be assumed that the first object 31 has a reflectance and a refractive index that are greater than 0 and each of the second object 32 and the third object 33 has a reflectance and a refractive index that are 0, i.e., the first object 31 reflects and refracts light whereas the second object 32 and the third object 33 do not reflect and refract light.

In the 3D model of FIG. 1, a rendering apparatus (for example, a ray tracing apparatus 100) may determine a viewpoint 10 in order to generate a 3D image and may determine an image plane 15 according to the determined viewpoint 10.

Once the viewpoint 10 and the image plane 15 are determined, the ray tracing apparatus 100 may generate a ray for each pixel of the image plane 15 from the viewpoint 10.

For example, as shown in FIG. 1, when the image plane 15 has a resolution of 4×3, the ray tracing apparatus 100 may generate a ray for each of the 12 pixels. For convenience of explanation, a ray for one pixel (for example, a pixel A) will now be explained.

Referring to FIG. 1, a primary ray 40 is generated for the pixel A from the viewpoint 10. The primary ray 40 passes through a 3D space and reaches the first object 31. The first object 31 may include a set of predetermined unit regions (hereinafter, referred to as primitives). The following description assumes for the sake of convenience that the primitives are triangles, but the primitives may be any polygons such as, for example, triangles or quadrangles.

A shadow ray 50, a reflection ray 60, and a refraction ray 70 may be generated at a hit point between the primary ray 40 and the first object 31. The shadow ray 50, the reflection ray 60, and the refraction ray 70 are referred to as secondary rays.

The shadow ray 50 is generated to be applied from the hit point to the light source 80. The reflection ray 60 is generated at an angle corresponding to an angle of incidence of the primary ray 40 and is assigned a weight according to a reflectance of the first object 31. The refraction ray 70 is generated at an angle corresponding to a refractive index of the first object 31 and the angle of incidence of the primary ray 40, and is assigned a weight according to the refractive index of the first object 31.

The ray tracing apparatus 100 determines whether the hit point is exposed to the light source 80 through the shadow ray 50. For example, as shown in FIG. 1, when the shadow ray 50 meets the second objet 32, a shadow may be formed at a hit point of the shadow ray 50.

Also, the ray tracing apparatus 100 determines whether the refraction ray 70 and the reflection ray 60 reach another object. For example, as shown in FIG. 1, no object exists in a direction in which the refraction ray 70 travels, and the reflection ray 60 reaches the third object 33. Accordingly, the ray tracing apparatus 100 checks coordinates and color information of a hit point of the third object 33, and generates a shadow ray 90 from the hit point of the third object 33. In this case, the ray tracing apparatus 100 determines whether the shadow ray 90 is exposed to the light source 80. Since the reflectance and the refractive index of the third object 33 are 0, a reflection ray and a refraction ray for the third object 33 are not generated.

As described above, the ray tracing apparatus 100 analyzes the primary ray 40 for the pixel A and all rays that are derived from the primary ray 40 and determines a color value of the pixel A according to a result of the analysis. The determination of the color value of the pixel A is affected by a color of a hit point of the primary ray 40, a color of a hit point of the reflection ray 60, and whether the shadow ray 50 reaches the light source 80.

The ray tracing apparatus 100 may construct the image plane 15 by performing the above process on all of the pixels of the image plane 15.

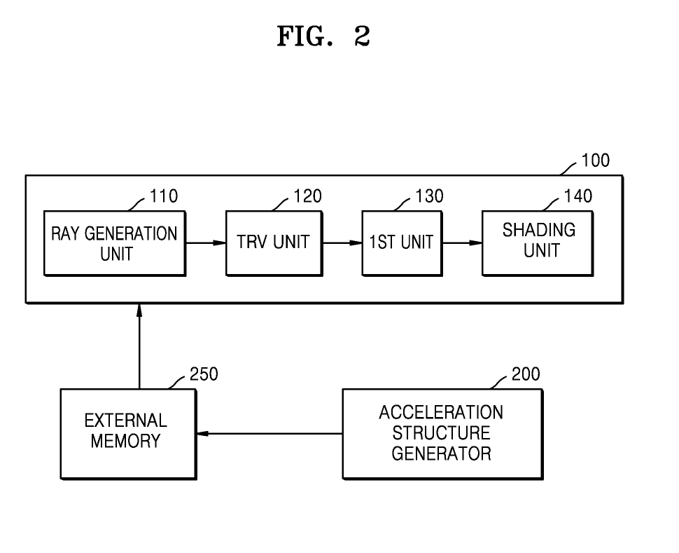

FIG. 2 is a diagram illustrating an example of a ray tracing system 20.

Referring to FIG. 2, the ray tracing system 20 may include the ray tracing apparatus 100, an external memory 250, and an acceleration structure (AS) generator 200. The ray tracing apparatus 100 may include a ray generation unit 110, a traversal (TRV) unit 120, an intersection test (IST) unit 130, and a shading unit 140.

The ray generation unit 110 may generate a primary ray and rays that are derived from the primary ray. The ray generation unit 110 may generate a primary ray from the viewpoint 10. As described with reference to FIG. 1, the ray generation unit 110 may generate a secondary ray at a hit point between the primary ray and an object. The secondary ray may be a reflection ray, a refraction ray, or a shadow ray that is generated at the hit point between the primary ray and the object.

The ray generation unit 110 may generate a tertiary ray at a hit point between the secondary ray and an object. The ray generation unit 110 may continuously generate a ray until any ray does not intersect the object or may generate a ray a predetermined number of times.

The TRV unit 120 may receive information about the ray that is generated by the ray generation unit 110. The generated ray includes the primary ray and the rays (e.g., the secondary ray, the tertiary ray, etc.) that are derived from the primary ray.

For example, for the primary ray, the TRV unit 120 may receive information about a viewpoint and a direction of the primary ray. For the secondary ray, the TRV unit 120 may receive information about a start point and a direction of the secondary ray. The start point of the secondary ray refers to the hit point between the primary ray and the object. The viewpoint or the start point may be expressed as coordinates and the direction may be expressed as a vector.

The TRV unit 120 may read information about an AS from the external memory 250. In this case, the AS is generated by the AS generator 200 and the generated AS is stored in the external memory 250.

The AS generator 200 may generate the AS including position information of objects in a 3D space. The AS generator 200 divides the 3D space in a hierarchical tree shape. The AS generator 200 may generate the AS having various shapes. For example, the AS generator 200 may generate the AS indicating a relationship of the objects in the 3D space by using a k-dimensional (kd) tree or a bounding volume hierarchy (BVH).

The AS may include a root node, an inner node, a leaf node, and a primitive. The term ‘root node’ refers to an uppermost node that does not have a parent node and has only a child node. The term ‘inner node’ refers to a node that has both a parent node and a child node. The term ‘leaf node’ refers to a lowermost node that does not have a child node and has only a parent node, the leaf node may include primitives.

The TRV unit 120 may detect a leaf node that intersects a ray by traversing the read information about the AS. The IST unit 130 may receive the leaf node that intersects the ray from the TRV unit 120.

The IST unit 130 may read, from the external memory 250, information (geometry data) about primitives that are included in the received leaf node.

The IST unit 130 may perform an intersection test between the ray and each of the primitives by using the information about the read information about the primitives. For example, the IST unit 130 may determine which primitive from among the primitives that are included in the leaf node received from the TRV unit 120 intersects the ray.

Accordingly, the IST unit 130 may detect a primitive that intersects the ray, and may calculate a hit point between the detected primitive and the ray.

The calculated hit point may be output as coordinates to the shading unit 140.

The shading unit 140 may determine a color value of a pixel based on information about the hit point and characteristics of a material of the hit point and. Also, the shading unit 140 may determine the color value of the pixel in consideration of a basic color of the material of the hit point and an effect of a light source.

For example, in FIG. 1, the shading unit 140 may determine a color value of the pixel A in consideration of effects of the primary ray 40, and the refraction ray 70, the reflection ray 60, and the shadow ray 50 that are secondary rays.

The ray tracing apparatus 100 may receive data that is necessary for ray tracing from the external memory 250. The external memory 250 may store the AS or geometry data.

The AS is generated by the AS generator 200 and is stored in the external memory 250.

Also, the geometry data refers to information about primitives. The primitives may be polygons such as triangles or quadrangles, and the geometry data may include information about positions and vertices of the primitives that are included in an object. For example, when the primitives are triangles, the geometry data may include vertex coordinates, normal vectors, or texture coordinates of the triangles.

The ray tracing apparatus 100 may detect a leaf node that intersects a ray by traversing the AS. The ray tracing apparatus 100 may traverse the AS along one path, and when a traversal process ends, may traverse the AS of another path. When the AS of the other path is traversed, the ray tracing apparatus 100 may store, in a stack, information about a node that is not traversed in order to improve traversal efficiency.

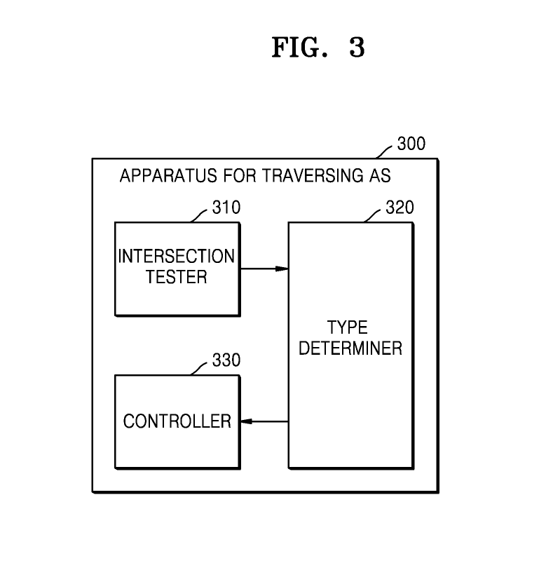

FIG. 3 is a diagram illustrating an example of an apparatus 300 for traversing an AS in the ray tracing system 10.

Referring to FIG. 3, the apparatus 300 may include an intersection tester 310, a type determiner 320, and a controller 330.

The intersection tester 310, the type determiner 320, and the controller 330 of FIG. 3 that are used to traverse the AS may be included in the TRV unit 120 or the IST unit 130 of FIG. 2. However, the present example is not limited thereto.

The intersection tester 310 determines whether any child node of a target node that is included in the AS intersects a ray. The intersection tester 310 may obtain information about the child node of the target node from the external memory 250. The information about the child node may include information that is necessary to determine a next target node. The information about the child node of the target node according to an example may include a memory address in which the child node is stored, an index indicating the child node, type information of the child node, and bounding box information of the child node. The term ‘bounding box’ refers to a smallest hexahedral space that may include an object that independently moves in a 3D space.

The intersection tester 310 determines whether each of child nodes of the target node intersects the ray based on the bounding box information about the child node of the target node.

For example, the intersection tester 310 may obtain information about a first child node of the target node from the external memory 250. The intersection tester 310 may determine whether the first child node intersects the ray based on the information about the first child node.

The target node may include child nodes. When the target node includes child nodes, the intersection tester 310 may obtain information about each of the child nodes and may determine whether each of the child nodes intersects the ray.

For example, when the target node includes a first child node and a second child node, the intersection tester 310 may obtain information about the first child node and may determine whether the first child node intersects the ray based on the obtained information about the first child node. Also, the intersection tester 310 may obtain information about the second child node and may determine whether the second child node intersects the ray based on the obtained information about the second child node.

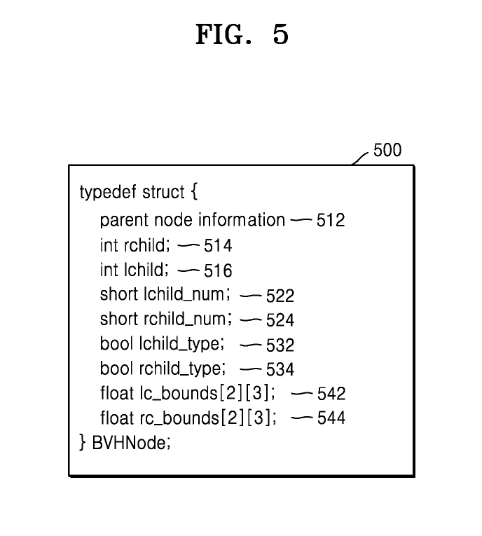

According to another example, the intersection tester 310 may simultaneously determine whether the child nodes intersect the ray. When the intersection tester 310 simultaneously determines whether the child nodes intersect the ray, information about all of the child nodes may be included in the information about the child node, which will now be explained in detail with reference to FIG. 5.

FIG. 5 is an example of a diagram explaining a data structure 500 in which information about child node of a target node is stored.

Referring to FIG. 5, the information about the child node of the target node may be included in the data structure 500. For example, the information about the child node of the target node may include identification information 514 and 516 for identifying the child node. When the child node is an inner node, the identification information may be index information 514 and 516 indicating the child node. When the child node is a leaf node, the identification information 514 and 516 is used to indicate a start index of any primitive that is included in the child node.

When the child node is a leaf node, in order to indicate the number of primitives that are included in the child node, the information about the child node of the target node may include primitive number information 522 and 524 indicating the number of primitives of the child node. When the child node is an inner node, the primitive number information 522 and 524 may be set to 0.

The information about the child node of the target node may include bounding box information 532 and 534 of the child node. Also, the information about the child node of the target node may further include information 512 about a parent node of the target node. However, the present example is not limited thereto, and the information about the child node of the target node may include information other than the above information.

The intersection tester 310 may simultaneously obtain information about child nodes that are included in the data structure 500 and may simultaneously determine whether the child nodes intersect the ray. When the target node is an inner node, primitive number information 522 and 524 indicating the child nodes may each indicate at least one primitive that is included in the target node.

An example where the target node includes two child nodes is explained below. The type determiner 320 determines a type of at least one child node that intersects the ray. Examples of a type of the target node may include an inner node and a leaf node.

When a leaf node is included in the at least one child node, the controller 330 performs an operation corresponding to the leaf node. After the type determiner 320 determines the type of the at least one child node that intersects the ray, the controller 330 may obtain information about a child node that is determined to be a leaf node.

When child nodes intersect the ray, the controller 330 may determine types of the child nodes. When the child nodes are all determined to be leaf nodes, the controller 330 may extract a child node from a stack in order to determine a next target node.

When the child nodes are all leaf nodes, the controller 330 may generate a list of primitives that are included in each of the child nodes. The controller 330 may transmit the generated list of the primitives to the IST unit 130. The IST unit 130 may determine whether each of the primitives intersects the ray based on the list of the primitives.

The IST unit 130 repeatedly performs an intersection test for determining whether at least one primitive that is included in the next target node intersects the ray. The IST unit 130 may detect a primitive that intersects the ray and may calculate a hit point between the detected primitive and the ray. The calculated hit point may be output as coordinates to the shading unit 140.

When some of the child nodes are leaf nodes, the controller 330 may determine a child node that is not the leaf nodes as a next target node. For example, the controller 330 may determine an inner node that is not the leaf nodes from among the child nodes that intersect the ray as a next target node.

When there are inner nodes in the plurality of child nodes that intersect the ray, the controller 330 may determine a child node whose intersection distance to the ray is the shortest as a next target node based on an intersection distance between a bounding box of each of the child nodes and the ray. Also, the controller 330 may generate a list of primitives that are included in the child nodes that are the leaf nodes.

For example, when a first child node is a leaf node and a second child node is an inner node, the controller 330 may determine the second child node as a next target node. Also, the controller 330 may generate a list of at least one primitive that is included in the first child node.

The controller 330 may transmit the generated list of the primitive(s) included in the first child node to the IST unit 130. The IST unit 130 may determine whether each primitive intersects the ray.

The IST unit 130 repeatedly performs an intersection test for determining whether each of at least one primitive that is included in the next target node intersects the ray. The IST unit 130 may detect a primitive that intersects the ray and may calculate a hit point between the detected primitive and the ray.

When there is no leaf node in the plurality of child nodes, the controller 330 determines a next target node based on an intersection distance between a bounding box that is included in each of the child nodes and the ray. The controller 330 may determine a child node having a bounding box whose intersection distance to the ray is the shortest as a next target node.

When no child node exists that intersects the ray, the controller 330 may extract a child node that is stored in the stack and may determine a next target node.

When no next target node exists, the controller 330 ends a series of traversal processes and transmits a result of the series of traversal processes to the shading unit 140. The shading unit 140 may determine a color value of a pixel corresponding to the ray based on information about a hit point between the ray and each of primitives and characteristics of a material of the hit point. Also, the shading unit 140 may also determine the color value of the pixel in consideration of a factors, such as, for example, basic color of the material of the hit point and an effect of a light source.

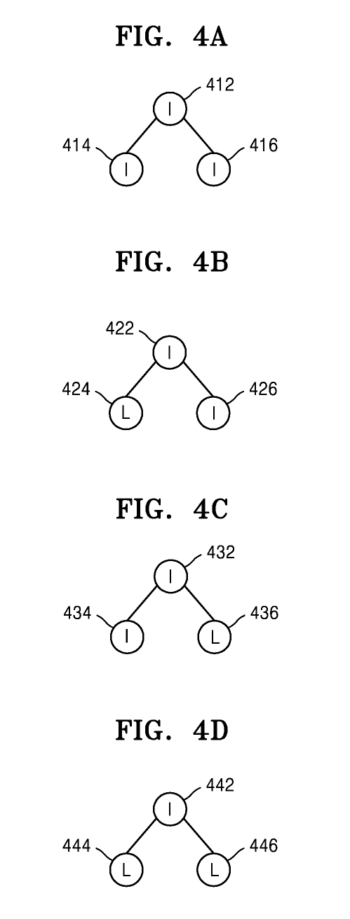

FIGS. 4A through 4D are diagrams illustrating examples for explaining an AS traversal process in the ray tracing system 10. For convenience of explanation, FIGS. 4A through 4D illustrate an example where the target node includes two child nodes, however, the present example is not limited thereto. For convenience of explanation, it is assumed that all child nodes in FIG. 4 intersect a ray.

Referring to FIG. 4A, a target node 412, a first child node 414, and a second child node 416 are all inner nodes. The apparatus 300 may determine a child node whose intersection distance to the ray is shorter from among a bounding box of the first child node 414 and a bounding box of the second child node 416 as a next target node.

Referring to FIG. 4B, a target node 422 and a second child node 426 are inner nodes, while a first child node 424 is a leaf node. The apparatus 300 may determine the second child node 426 as a next target node and may generate a list of at least one primitive that is included in the first child node 424.

Referring to FIG. 4C, a target node 432 and a first child node 434 are inner nodes, while a second child node 436 is a leaf node. The apparatus 300 may determine the first child node 434 as a next target node and may generate a list of at least one primitive that is included in the second child node 436.

Referring to FIG. 4D, a target node 442 is an inner node and a first child node 444 and a second child node 446 are leaf nodes. The apparatus 300 may extract a child node for determining a next target node from a stack. The apparatus 300 determines the extracted child node as a next target node. Also, the apparatus 300 may generate a list of primitives that are included in each of the first child node 444 and the second child node 446.

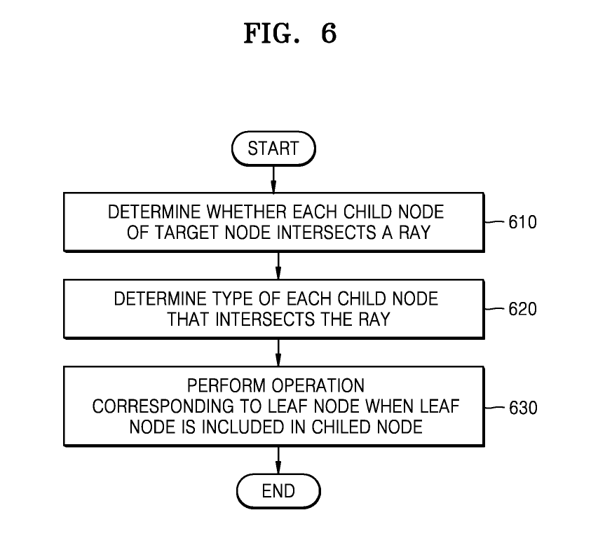

FIG. 6 is a diagram of a method of traversing an AS in the ray tracing system 10. The operations in FIG. 6 may be performed in the sequence and manner as shown, although the order of some operations may be changed or some of the operations omitted without departing from the spirit and scope of the illustrative examples described. Many of the operations shown in FIG. 6 may be performed in parallel or concurrently. The above descriptions of FIGS. 1-5, is also applicable to FIG. 6, and is incorporated herein by reference. Thus, the above description may not be repeated here.

In 610, the apparatus 300 determines whether each child node of a target node that is included in the AS intersects a ray. The apparatus 300 may obtain information about the child nodes of the target node from the external memory 250. The information about the child node may include information that is necessary to determine a next target node. The information about the child node of the target node according to an example may include a memory address in which the child node is stored, an index indicating the child node, type information of the child node, and bounding box information of the child node.

When the target node includes a plurality of child nodes, the apparatus 300 may obtain information about each of the child nodes and may sequentially determine whether the plurality of child nodes intersect the ray.

For example, when the target node includes a first child node and a second child node, the apparatus 300 may obtain information about the first child node and may determine whether the first child node intersects the ray based on the obtained information about the first child node. Also, the apparatus 300 may obtain information about the second child node and may determine whether the second child node intersects the ray based on the obtained information about the second child node. According to another example, the apparatus 300 may simultaneously determine whether the plurality of child nodes intersect the ray.

In 620, the apparatus 300 determines a type of at least one child node that intersects the ray. The apparatus 300 may determine the type of the at least one child node that intersects the ray. Examples of a type of the target node may include an inner node and a leaf node.

In 630, when a leaf node is included in the at least one child node, the apparatus 300 performs an operation corresponding to the leaf node. After the type determiner 320 determines a type of the at least one child node that intersects the ray, the apparatus 300 may obtain information about a child node that is determined to be the leaf node.

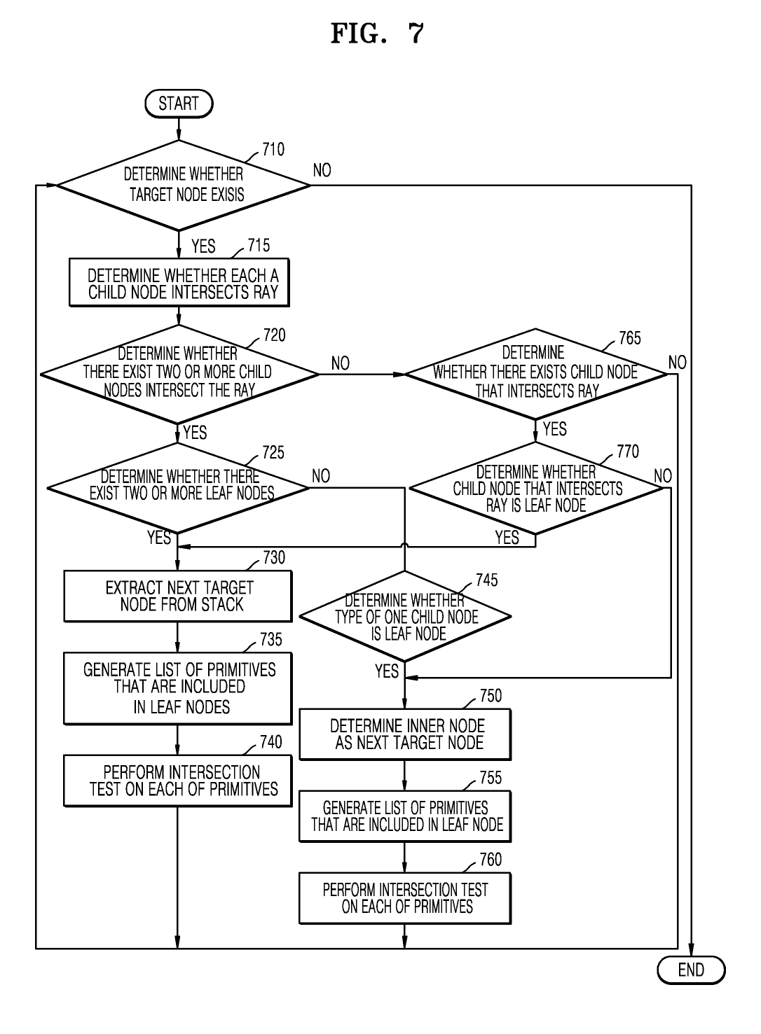

FIG. 7 is a diagram illustrating an example of an AS traversal process in the ray tracing system 10. FIG. 7 describes how the apparatus 300 performs an operation according to a type of each of child nodes that intersects a ray. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. The above descriptions of FIGS. 1-6, is also applicable to FIG. 7, and is incorporated herein by reference. Thus, the above description may not be repeated here.

In 710, the apparatus 300 may determine whether a target node exists. For example, the apparatus 300 may determine whether a node is stored in a stack. When no nodes are in the stack, the apparatus 300 may end the AS traversal process.

In 715, the apparatus 300 may determine whether each child nodes of the target node intersects a ray. The apparatus 300 may obtain information about any child node of the target node from the external memory 250. When the target node includes a plurality of child nodes, the apparatus 300 may obtain information about each of the child nodes and may sequentially determine whether the child nodes intersect the ray. Operation 715 may correspond to operation 610 of FIG. 6. The above description of operation 610 of FIG. 6, is incorporated herein by reference. Thus, the above description may not be repeated here.

In 720, the apparatus 300 may determine whether two or more child nodes intersect the ray.

In 725, the apparatus 300 may determine whether all of the two or more child nodes that intersect the ray are leaf nodes. The apparatus 300 may determine whether the two or more child nodes that intersect the ray are leaf nodes based on the information about the child node obtained in operation 710.

In 730, the apparatus 300 may extract a next target node from a stack. The apparatus 300 may extract a node that is stored in the stack and may determine a next target node. The apparatus 300 may determine a next target node before performing an operation on the leaf nodes determined in operation 725, thereby reducing a time taken to perform the AS traversal process.

In 735, the apparatus 300 may generate a list of primitives that are included in the leaf nodes.

In 740, the apparatus 300 may determine whether each of the primitives that are included in the leaf nodes intersects the ray.

In 745, the apparatus 300 may determine whether a type of one child node that intersects the ray is a leaf node.

When it is determined in operation 720 that there do not exist two or more child nodes that intersect the ray, in 765, the apparatus 300 may determine whether there exists one child node that intersects the ray.

When there exists one child node that intersects the ray, the apparatus 300 may perform 770 to determine whether the one child node that intersects the ray is a leaf node. When there does not exist one child node that intersects the ray, the apparatus 300 may perform operation 710.

In 770, the apparatus 300 determines whether the one child node that intersects the ray is a leaf node. When the one child node that intersects the ray is a leaf node, the apparatus 300 may extract a node from the stack and may determine the extracted node as a next target node. When the one child node that intersects the ray is a leaf node, the apparatus 300 may perform operations 730 through 740. The apparatus 300 according to an example may determine a next target node before performing an operation on the determined leaf node, thereby reducing a time taken to perform the AS traversal process.

When the one child node that intersects the ray is not a leaf node, the apparatus 300 may perform operations 750 through 760 on the one child node that intersects the ray.

In 750, the apparatus 300 may determine another child node that is an inner node as a next target node. When a type of one child node that intersects the ray is a leaf node, the apparatus 300 may determine another child node as a next target node. For example, when a first child node is a leaf node from among the first child node and a second child node that intersect the ray, the apparatus 300 may determine an inner node as the second child node.

In 755, the apparatus 300 may generate a list of at least one primitive that is included in the one child node that is a leaf node.

In 760, the apparatus 300 may determine whether each of the at least one primitive that is included in the generated list intersects the ray. The apparatus 300 may perform operation 710 after determining whether each of the at least one primitive that is included in the generated list intersects the ray.

FIG. 8 is a diagram illustrating an example for explaining an operation between the TRV unit 120 and the IST unit 130 in the ray tracing system 10. A case where the apparatus 300 is included in the TRV unit 120 and the IST unit 130 will be exemplarily explained in FIG. 8. The operations in FIG. 8 may be performed in the sequence and manner as shown, although the order of some operations may be changed or some of the operations omitted without departing from the spirit and scope of the illustrative examples described. Many of the operations shown in FIG. 8 may be performed in parallel or concurrently. The above descriptions of FIGS. 1-7, is also applicable to FIG. 8, and is incorporated herein by reference. Thus, the above description may not be repeated here.

In 810, the TRV unit 120 may determine whether each of child nodes of a target node intersects a ray. Operation 810 may correspond to operation 610. The above description of operation 610 of FIG. 6, is incorporated herein by reference. Thus, the above description may not be repeated here.

In operation 820, the TRV unit 120 may determine a type of at least one child node that intersects the ray. Operation 820 may correspond to operation 620. The above description of operation 620 of FIG. 6, is incorporated herein by reference. Thus, the above description may not be repeated here.

In operation 830, when a leaf node is included in the at least one child node, the TRV unit 120 may determine an operation corresponding to the leaf node. Operation 830 may correspond to operation 630. The above description of operation 630 of FIG. 6, is incorporated herein by reference. Thus, the above description may not be repeated here.

In operation 840, the IST unit 130 may receive a list of primitives that are included in a child node, which is determined to be the leaf node, that intersects the ray.

In operation 850, the IST unit 130 may determine whether a primitive that is included in the list intersects the ray.

In operation 860, when it is determined whether one primitive intersects the ray, the IST unit 130 may determine whether a next primitive intersects the ray. The IST unit 130 may repeatedly perform operations 850 and 860 until it is completely determined whether all of primitives that are included in the list intersect the ray.

As described above, according to the one or more of the above examples, since an object to be traversed is determined according to a type of a child node during an AS traversal process, the AS traversal process may be efficiently performed. Accordingly, the performance and processing speed of a ray tracing system may be improved.

The apparatuses, units, modules, devices, and other components illustrated in FIGS. 1-5 that perform the operations described herein with respect to FIGS. 1-5 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-5. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 6-8 that perform the operations described herein with respect to FIGS. 6-8 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of traversing an acceleration structure (AS) in ray tracing, the method comprising:
determining whether each child node of a target node that is included in the AS intersects a ray;
determining a type of a child node that intersects the ray; and
performing an operation corresponding to a leaf node, in response to the child node being the leaf node.

2. The method of claim 1, further comprising:
determining a child node that is not the leaf node as a next target node;
the performing of the operation comprises generating a list of primitives included in the leaf node; and
determining whether at least one primitive included in the primitives intersects the ray.

3. The method of claim 1, wherein the performing of the operation comprises:
extracting a child node stored in a stack, in response to the each child node of the target node being a leaf node;
determining the extracted child node as a next target node; and
determining whether primitives that are included in the each child node of the target node intersects the ray.

4. The method of claim 3, wherein the determining of whether the primitives intersect the ray comprises:
generating a list of the primitives that are included in the each child node of the target node; and
determining whether each primitive in the generated list intersects the ray.

5. The method of claim 1, wherein the performing of the operation comprises:
setting a child node whose intersection distance to the ray is the shortest from among child nodes whose types are different to a next target node, in response to the child node being the leaf node; and
determining whether at least one primitive included in the one child node intersects the ray.

6. The method of claim 1, wherein the target node comprises type information of the each child node.

7. The method of claim 1, wherein the target node comprises index information for identifying each child node whose types is the same.

8. The method of claim 7, wherein the index information is index information of at least one primitive that is included in the leaf node, in response to the type of the child node being the leaf node.

9. The method of claim 1, wherein the target node comprises child nodes and the determining of whether the each child node intersects the ray comprises simultaneously determining whether the child nodes of the target node intersect the ray.

10. A non-transitory computer-readable recording medium having embodied thereon a program for executing the method of claim 1.

11. An apparatus for traversing an acceleration structure (AS) in a ray tracing system, the apparatus comprising:
an intersection tester configured to determine whether each child node of a target node that is included in the AS intersects a ray;
a type determiner configured to determines a type of a child node that intersects the ray; and
a controller configured to perform an operation corresponding to a leaf node, in response to the child node being the leaf node.

12. The apparatus of claim 11, wherein the controller is further configured to determine a child node that is not the leaf node as a next target node and to determine whether at least one primitive included in the leaf node intersects the ray.

13. The apparatus of claim 11, wherein in response to the each child node of the target node being a leaf node, the controller is further configured to:
extract a child node that is stored in a stack,
determine the extracted child node as a next target node, and
determine whether primitives included in the each child node of the target node intersects the ray.

14. The apparatus of claim 13, wherein the intersection tester is further configured to generate a list of the primitives that are included in the each child node of the target node and to determine whether each primitive included in the generated list intersects the ray.

15. The apparatus of claim 11, wherein the controller is further configured to set a child node whose intersection distance to the ray is the shortest from among child nodes whose types are different to a next target node, in response to the child node being the leaf node, and to determine whether at least one primitive included in the one child node intersects the ray.

16. The apparatus of claim 11, wherein the target node comprises type information of each of the child nodes.

17. The apparatus of claim 11, wherein the target node comprises index information for identifying each child node whose types is the same.

18. The apparatus of claim 17, wherein the index information is index information about at least one primitive that is included in the leaf node, in response to the type of the child node being the leaf node.

19. The apparatus of claim 11, wherein the target node comprises child nodes and the intersection tester is further configured to simultaneously determine whether the child nodes of the target node intersect the ray.

20. The apparatus of claim 11, wherein the controller is further configured to track information regarding child nodes that do not intersect the ray.
